(19) United States
(12) Patent Application Publication
(10) Pub. No.: US 2020/0410778 A1
(43) Pub. Date: Dec. 31, 2020

(54) VEHICLE CONSUMABLE MANAGEMENT SYSTEM, TERMINAL DEVICE, COMPUTER PROGRAM, AND VEHICLE CONSUMABLE MANAGEMENT METHOD

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi, Osaka (JP)

(72) Inventors: Shinichi Aiba, Yokkaichi, Mie (JP); Tomohiro Mizutani, Yokkaichi, Mie (JP); Hiroshi Tateishi, Yokkaichi, Mie (JP); Shogo Kamiguchi, Yokkaichi, Mie (JP)

(73) Assignees: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi, Osaka (JP)

(21) Appl. No.: 16/492,344

(22) PCT Filed: Feb. 21, 2018
(86) PCT No.: PCT/JP2018/006101

§ 371 Date: Sep. 9, 2019

(30) Foreign Application Priority Data
Mar. 9, 2017 (JP) 2017-045263

(51) Int. Cl. G07C 5/00; G07C 5/08; G06Q 10/00

(52) U.S. Cl. CPC G07C 5/006; G06Q 10/20; G07C 5/008; G07C 5/0808

(57) ABSTRACT

In the vehicle consumable management system, a gateway device of the vehicle collects information relating to consumables, and transmits the collected information to a server device, and the server device stores the received vehicle information. A smartphone used by a user receives vehicle information from the server device, and determines, based on the received vehicle information and a determination condition stored in the storage unit, the time to, for example, replace or refill the consumables of the vehicle, and displays a result of the determination as a notification screen to notify the user of the result of the determination. Furthermore, the smartphone accepts an operation for setting the determination condition for determining a replacement time, and changes the determination condition stored in the storage unit.

### CROSS-REFERENCE TO RELATED APPLICATIONS

This application is the U.S. national stage of PCT/JP2018/006101 filed on Feb. 21, 2018, which claims priority of Japanese Patent Application No. JP 2017-045263 filed on Mar. 9, 2017, the contents of which are incorporated herein.

### TECHNICAL FIELD

The present disclosure relates to a vehicle consumable management system, a terminal device, a computer program, and a vehicle consumable management method with which consumables of a vehicle are managed.

### BACKGROUND

Vehicles are equipped with a large number of consumables such as, for example, engine oil, oil filters, windshield wiper blade rubber, and batteries, that is, components that need to be, for example, replaced or refilled when they are worn out or consumed, for example. Conventionally, a system for prompting a user to replace such a consumable of a vehicle has been proposed.

For example, JP 2002-269260A has proposed a vehicle management device that determines a time to replace or refill consumables of a vehicle, accesses a database of dealers that deal with a consumable that needs to be replaced or refilled, and notifies the user of the stock status and the like.

The management device disclosed in JP 2002-269260A determines whether or not a consumable of the vehicle needs to be replaced or refilled based on a predetermined threshold. The threshold that is used in the determination is preset as a value recommended for replacement or refill of the consumable by, for example, the manufacturer of the vehicle or the sales company of the consumable, and is common for all vehicles. However, the time period until a consumable is replaced or refilled may vary depending on the frequency or manner of use of the vehicle by the user, for example. Also, there may be users who want to use a consumable as long as possible even after the recommended replacement time has elapsed, and users who want to replace the consumable with priority given to travel comfort or the like even before the lapse of the recommended replacement time. The management device disclosed in JP 2002-269260A has the problem that a user's intention is not reflected in determination of whether or not a consumable is to be, for example, replaced or refilled, and thus the management device is not necessarily convenient for the user.

The present disclosure was made in view of the aforementioned circumstances, and it is an object thereof to provide a vehicle consumable management system, a terminal device, a computer program, and a vehicle consumable management method with which it is possible to realize management of consumables of a vehicle that reflects a user's intention.

### SUMMARY

According to the present disclosure, a vehicle consumable management system includes: an on-board communication device that is installed in a vehicle, and includes an information collecting unit configured to collect information relating to consumables of the vehicle, and a vehicle information transmitting unit configured to transmit the information collected by the information collecting unit to a device outside the vehicle; a vehicle-external device that includes a vehicle information receiving unit configured to receive the information transmitted by the on-board communication device, a vehicle information storage unit configured to store the information received by the vehicle information receiving unit, and a vehicle information transmitting unit configured to transmit the information stored in the vehicle information storage unit to a terminal device; and a terminal device that includes a vehicle information receiving unit configured to receive the information transmitted by the vehicle-external device, a replacement time determination unit configured to determine, based on the information received by the vehicle information receiving unit and a predetermined determination condition, a time to replace a consumable of the vehicle, an accepting unit configured to accept a setting operation for setting the determination condition, a condition changing unit configured to change the determination condition based on the setting operation accepted by the accepting unit, and a notification unit configured to perform notification of the time to replace the consumable of the vehicle based on a result of the determination performed by the replacement time determination unit.

Furthermore, the vehicle consumable management system according to the present disclosure may be such that the on-board communication device includes a transmission allowability table in which, for each type of information, a setting as to whether or not the information is allowed to be transmitted to the outside of the vehicle is stored, and the vehicle information transmitting unit of the on-board communication device transmits information that is allowed to be transmitted based on the transmission allowability table.

Furthermore, the vehicle consumable management system according to the present disclosure may be such that the terminal device includes an accepting unit configured to accept an operation for setting the transmission allowability table, and a setting information transmitting unit configured to transmit, to the vehicle-external device, setting information that corresponds to the setting operation accepted by the accepting unit, the vehicle-external device includes a setting information receiving unit configured to receive the setting information transmitted by the terminal device, and a setting information storage unit configured to store the setting information received by the setting information receiving unit, and a setting information transmitting unit configured to transmit the information stored in the setting information storage unit to the on-board communication device, and the on-board communication device includes a setting information receiving unit configured to receive the setting information transmitted by the vehicle-external device, and a setting updating unit configured to update settings of the transmission allowability table based on the setting information received by the setting information receiving unit.

Furthermore, the vehicle consumable management system according to the present disclosure may be such that the notification unit of the terminal device performs processing for displaying, on a display unit, a first notification screen that contains information relating to a consumable whose replacement time determined by the replacement time determination unit has come, or a consumable whose replacement time is within a predetermined time period.

Furthermore, the vehicle consumable management system according to the present disclosure may be such that the notification unit of the terminal device performs processing for displaying, on the display unit, a second notification screen that indicates a list of consumables of the vehicle, each consumable being associated with a replacement time determined by the replacement time determination unit.

Furthermore, the vehicle consumable management system according to the present disclosure may be such that the notification unit of the terminal device performs processing for displaying, on the display unit, a determination condition notification screen that indicates a list of consumables of the vehicle, each consumable being associated with a determination condition for use in determination performed by the replacement time determination unit, and the accepting unit of the terminal device accepts an operation for setting the determination condition on the determination condition notification screen displayed on the display unit.

Furthermore, the vehicle consumable management system according to the present disclosure may be such that the determination condition notification screen displays a determination condition set for each consumable, as well as information regarding a recommended determination condition.

Furthermore, according to the present disclosure, a terminal device includes: a vehicle information receiving unit configured to receive information relating to consumables of a vehicle that is transmitted from a vehicle-external device; a replacement time determination unit configured to determine, based on the information received by the vehicle information receiving unit and a predetermined determination condition, a time to replace a consumable of the vehicle; an accepting unit configured to accept a setting operation for setting the determination condition; a condition changing unit configured to change the determination condition based on the setting operation accepted by the accepting unit; and a notification unit configured to perform notification of the time to replace the consumable of the vehicle based on a result of the determination performed by the replacement time determination unit.

Furthermore, according to the present disclosure, a computer program causes a computer to function as: a vehicle information receiving unit configured to receive information relating to consumables of a vehicle that is transmitted from a vehicle-external device; a replacement time determination unit configured to determine, based on the information received by the vehicle information receiving unit and a predetermined determination condition, a time to replace a consumable of the vehicle; an accepting unit configured to accept a setting operation for setting the determination condition; a condition changing unit configured to change the determination condition based on the setting operation accepted by the accepting unit; and a notification unit configured to perform notification of the time to replace the consumable of the vehicle based on a result of the determination performed by the replacement time determination unit.

Furthermore, according to the present disclosure, a vehicle consumable management method includes the steps of collecting, by a vehicle, information relating to consumables and transmitting the collected information to the outside of the vehicle; determining, based on the information transmitted by the vehicle and a predetermined determination condition, a time to replace a consumable of the vehicle; accepting a setting operation for setting the determination condition; changing the determination condition based on the accepted setting operation; and performing notification of the time to replace the consumable of the vehicle based on a result of the determination.

According to the present disclosure, the on-board communication device installed in a vehicle collects information relating to consumables of the vehicle, and transmits the collected information to the vehicle-external device, and the vehicle-external device stores the received vehicle information. The terminal device that is used by a user receives the vehicle information from the vehicle-external device, determines, based on the received information and a predetermined determination condition, a time to replace (refill) a consumable of the vehicle, and notifies the user of a result of the determination. Furthermore, the terminal device accepts, from the user, a setting operation for setting the determination condition for determining a replacement time, and changes the determination condition.

With this, a user's intention can be reflected in the determination condition for determining the time to replace or refill consumables of the vehicle. Furthermore, as a result of the terminal device accepting a setting operation, convenience when the user performs setting operation can be improved.

Furthermore, according to the present disclosure, the on-board communication device includes a transmission allowability table in which, for each type of information, a setting as to whether or not the information is allowed to be transmitted to the outside of the vehicle is stored, and the on-board communication device transmits, to the vehicle-external device, information that is allowed to be transmitted based on the transmission allowability table, but does not transmit information that is not allowed to be transmitted. Accordingly, it is possible to suppress transmission of unnecessary information from the on-board communication device to the vehicle-external device, making it possible to reduce communication loads.

Furthermore, the terminal device accepts a setting operation for setting the transmission allowability table of the on-board communication device, and transmits, to the vehicle-external device, setting information that corresponds to the accepted operation. The vehicle-external device that has received the setting information from the terminal device stores the setting information, and transmits the setting information to the on-board communication device. The on-board communication device updates the transmission allowability table based on the setting information received from the vehicle-external device. Accordingly, it is possible to reflect a user's intention, and restrict information transmission by the on-board communication device.

Furthermore, according to the present disclosure, the terminal device displays, on the display unit, the first notification screen that contains information relating to a consumable whose replacement time has come, or a consumable whose replacement time is within a predetermined time period. Accordingly, the user can view the first notification screen displayed on the terminal device to easily determine whether or not a consumable of the vehicle needs to be replaced.

Furthermore, according to the present disclosure, the terminal device displays, on the display unit, the second notification screen that indicates a list of consumables of the vehicle, each consumable being associated with a replacement time. Accordingly, the user can view the second notification screen displayed on the terminal device to easily recognize what kinds of consumables the vehicle is equipped with, how close replacement time of the consumables is approaching, and the like.

Furthermore, according to the present disclosure, the terminal device displays, on the display unit, the determination condition notification screen that indicates a list of consumables of the vehicle, each consumable being associated with a determination condition for use in replacement time determination, and accepts an operation for setting a determination condition on this determination condition notification screen. Accordingly, the user can easily recognize in what condition each consumable needs to be replaced, and can easily change the determination condition based on the user's own judgment.

Note that the terminal device may also display a determination condition set for each consumable, as well as a recommended determination condition. Accordingly, the user can easily determine whether or not the determination condition has been changed, and can easily recognize a difference between the determination condition set by himself or herself, and the recommended determination condition.

### ADVANTAGEOUS EFFECTS OF DISCLOSURE

According to the present disclosure, by employing a configuration in which a terminal device accepts an operation for setting a determination condition for determining the time to replace a consumable of a vehicle, changes the determination condition, determines the time to replace the consumable based on this determination condition, and notifies a user of the replacement time, it is possible to reflect a user's intention in the determination condition for determining the time to replace or refill the consumable of the vehicle, and thus realize management of consumables of the vehicle that reflects a user's intention.

### BRIEF DESCRIPTION OF DRAWINGS

FIG. 1 is a diagram schematically illustrating a configuration of a vehicle consumable management system according to an embodiment.

FIG. 2 is a block diagram illustrating a configuration of a gateway device.

FIG. 3 is a block diagram illustrating a configuration of a server device.

FIG. 4 is a block diagram illustrating a configuration of a smartphone.

FIG. 5 is a diagram schematically illustrating an example of a notification screen displayed on the smartphone.

FIG. 6 is a diagram schematically illustrating an example of a notification screen displayed on the smartphone.

FIG. 7 is a diagram schematically illustrating an example of a notification screen displayed on the smartphone.

FIG. 8 is a block diagram illustrating a configuration of a dealer terminal device.

FIG. 9 is a flowchart illustrating a procedure of processing that is executed by the gateway device of a vehicle.

FIG. 10 is a flowchart illustrating a procedure of processing that is executed by the server device.

FIG. 11 is a flowchart illustrating a procedure of processing that is executed by the smartphone.

FIG. 12 is a flowchart illustrating a procedure of processing that is executed by the dealer terminal device.

### DETAILED DESCRIPTION OF PREFERRED EMBODIMENTS

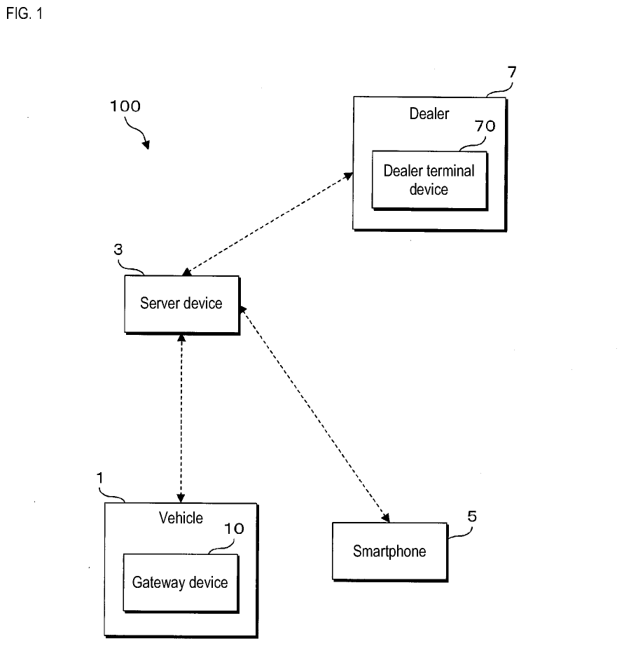

FIG. 1 is a diagram schematically illustrating a configuration of a vehicle consumable management system according to an embodiment. The vehicle consumable management system 100 according to the present embodiment is a system for managing various types of consumables equipped in a vehicle 1 in such a manner that a gateway device 10 installed in the vehicle 1, a server device 3 provided outside the vehicle, a smartphone 5 that is used by a user of the vehicle 1, and a dealer terminal device 70 provided at a dealer 7 of the vehicle 1 communicate with each other to exchange information. Examples of the consumables of the vehicle 1 that are managed by this system include engine oil, oil filters, air conditioner filters, windshield wiper blade rubber, a smoke canister, batteries, tires, brake pads, spark plugs, air cleaner elements, V-belts, differential oil, transmission oil, AT fluid, a clutch, drive shaft dust boots, a damper, power steering fluid, spark plug cords, timing belts, thermostats, radiator hoses, brake hoses, brake calipers, tie-rod ends, fuel filters, alternator brushes, fuel injectors, springs, headlights, windshield washer fluid, coolant water, and/or, brake fluid.

The gateway device 10 is an on-board communication device, and can communicate with devices provided inside and outside the vehicle 1. The gateway device 10 collects, from an Electronic Control Unit (ECU) or the like installed in the vehicle 1, information necessary for determining the time to replace consumables of the vehicle 1, and accumulates the collected information. The gateway device 10 transmits the collected information to the server device 3 at a predetermined timing such as a timing at which an ignition (IG) switch of the vehicle 1 is turned on/off, for example. Note that, in the present embodiment, the gateway device 10 is assumed to be an on-board communication device, but the present disclosure is not limited to this, and the gateway device 10 may also be another ECU, a car navigation device installed in the vehicle 1, or the like.

The server device 3 is an external device that is provided outside the vehicle 1, and is managed and operated by, for example, the manufacturer of the vehicle 1, a sales company, or the like. The server device 3 receives information transmitted from the gateway device 10 of the vehicle 1, and stores the received information. Note that, because the server device 3 can communicate with a plurality of vehicles 1 and can receive information from a plurality of gateway devices 10, the server device 3 stores information received from the gateway devices 10 in association with, for example, identification information regarding the vehicles 1, or the like. Furthermore, the server device 3 transmits stored information regarding the vehicle 1 in response to a request from the smartphone 5 used by a user. Note that, in the present embodiment, there is one server device 3, but the present disclosure is not limited to this, and a configuration is also possible in which a plurality of server devices cooperate with each other to realize the functions of the server device 3 according to the present embodiment.

The smartphone 5 is a terminal device that is used by the user of the vehicle 1. In the present embodiment, an example is given in which the smartphone 5 is a terminal device that is used by the user, but a terminal device such as a mobile phone, a tablet terminal device, a notebook personal computer, a wearable terminal device, or a portable video game player may also be used. Furthermore, the terminal device is preferably a portable device, but may also be a stationary device such as, for example, a stationary personal computer provided in the home of the user, or a car navigation device provided in the vehicle 1. An application program (hereinafter, referred to as “vehicle consumable management application”) for executing processing relating to the vehicle consumable management system 100 is installed in the smartphone 5, and by executing the vehicle consumable management application, the smartphone 5 functions as the terminal device of the vehicle consumable management system 100.

The smartphone 5 that executes the vehicle consumable management application communicates with the server device 3 to acquire predetermined information relating to the vehicle 1. The smartphone 5 executes processing for determining, based on the acquired information, a time to replace (refill) consumables equipped in the vehicle 1, and notifies the user of results of the determination. For example, if a consumable is equipped that is recommended to be replaced every ten thousand kilometers the vehicle 1 travels, the smartphone 5 acquires the mileage (distance traveled) of the vehicle 1 from the server device 3, calculates the travel distance for which the vehicle 1 has traveled after the previous replacement of this consumable, and determines whether or not the calculated travel distance exceeds ten thousand kilometers. If the travel distance exceeds ten thousand kilometers, the smartphone 5 notifies the user of the fact that the time has come to replace this consumable. Furthermore, the smartphone 5 may also notify, while allowing some margin of time, the user of the fact that the time to replace the consumable is approaching when the travel distance exceeds a distance obtained by (ten thousand kilometers—10%), for example.

In the vehicle consumable management system 100 according to the present embodiment, the user can operate the smartphone 5 to change a determination condition for determining the time to replace a consumable of the vehicle 1. In the above-described example, the user can increase or decrease the threshold “ten thousand kilometers” that serves as a condition for determining a replacement time, as appropriate or within some degree of restrictions. Accordingly, in the vehicle consumable management system 100 of the present embodiment, a user's intention can be reflected in a determination condition for determining the time to replace a consumable of the vehicle 1, and it is possible to realize management of the consumable of the vehicle 1 that reflects a user's intention.

The dealer terminal device 70 is a device provided at the dealer 7 of the vehicle 1, and may be, for example, a stationary computer, a notebook computer, a tablet terminal device, or the like. The dealer terminal device 70 is a device for allowing a working staff member, a maintenance staff member, or the like of the dealer 7 to, for example, manage or browse information relating to vehicles 1 that were sold, inspected, or repaired by the dealer 7, for example. Information relating to vehicles 1 is managed by the server device 3 (and another server device), and the dealer terminal device 70 can access the server device 3 via the Internet to allow browsing, updating, or the like of the information relating to vehicles 1. In the present embodiment, after a consumable was, for example, replaced or refilled by the dealer 7 during, for example a car inspection or a periodic inspection of the vehicle 1, or the like, information relating to the consumable that was, for example, replaced or refilled is input to the dealer terminal device 70 by an operator or the like of the dealer 7. The replacement information input to the dealer terminal device 70 is transmitted to the server device 3, and is further transmitted from the server device 3 to the smartphone 5. The smartphone 5 acquires, from the replacement information received by the server device 3, information such as the date when the consumable was replaced, and can use the acquired information as a standard for determination of the replacement time.

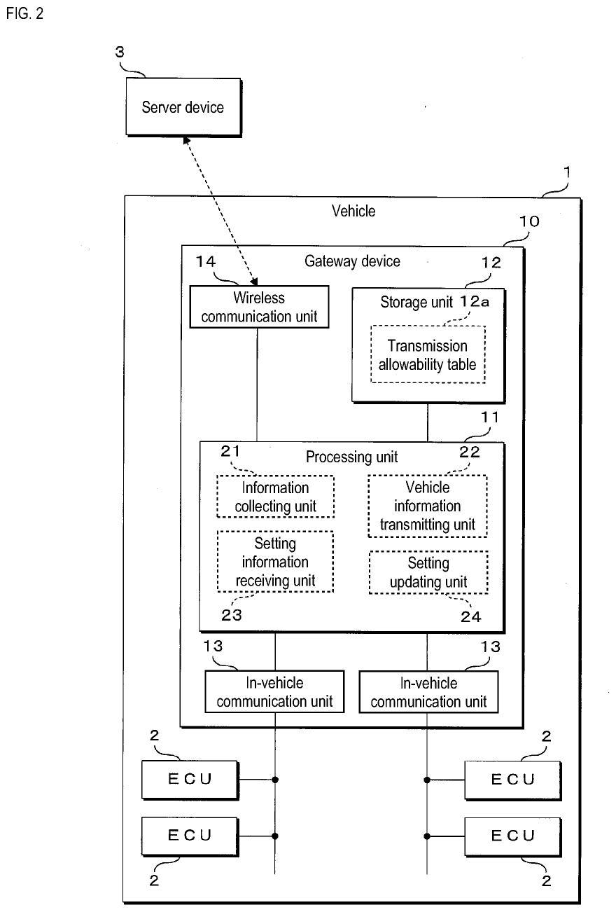

FIG. 2 is a block diagram showing a configuration of the gateway device 10. The gateway device 10 according to the present embodiment is provided with a processing unit (processor) 11, a storage unit (storage) 12, an in-vehicle communication units 13, and a wireless communication unit 14, and the like. The processing unit 11 is configured by, for example, an arithmetic processing unit such as a Central Processing Unit (CPU) or a Micro-Processing Unit (MPU), and performs various types of processing such as calculation processing and control processing by reading and executing programs (illustration thereof is omitted) stored in the storage unit 12. For example, the processing unit 11 performs processing for relaying communication between a plurality of ECU 2 installed in the vehicle 1, processing for relaying communication between devices provided inside and outside the vehicle 1, and the like. Furthermore, the processing unit 11 of the gateway device 10 according to the present embodiment performs processing for collecting information relating to consumables of the vehicle 1, processing for transmitting the collected information to the server device 3 provided outside the vehicle 1, and the like.

The storage unit 12 is configured by, for example, a nonvolatile memory device such as a flash memory or an Electrically Erasable Programmable Read Only Memory (EEPROM). The storage unit 12 stores programs that are executed by the processing unit 11, data required for the execution of the programs, and the like. Furthermore, the storage unit 12 of the gateway device 10 according to the present embodiment stores a transmission allowability table 12a. The transmission allowability table 12a is a table in which, for each piece of information to be transmitted/received in an in-vehicle network of the vehicle 1, a setting as to whether or not the information is allowed to be transmitted by the gateway device 10 to the server device 3 provided outside the vehicle 1. The gateway device 10 transmits, to the server device 3, information that is allowed to be transmitted based on the transmission allowability table 12a, but does not transmit, to the server device 3, information that is not allowed to be transmitted.

Communication wires that constitute the in-vehicle network of the vehicle 1 are connected to the in-vehicle communication units 13, and the in-vehicle communication units 13 transmit/receive information to/from the ECUs 2 connected to this communication wires. For example, the in-vehicle communication units 13 can be configured to transmit/receive information in accordance with the Controller Area Network (CAN) communication standard. Upon receiving digital information to be transmitted to an ECU 2 from the processing unit 11, the in-vehicle communication units 13 transmit this information by converting the information into electric signals and outputting the converted electric signals to the corresponding communication wire.

Furthermore, by sampling and obtaining the electric potential of the communication wire, the in-vehicle communication units 13 receive information transmitted by an ECU 2, and give the received information to the processing unit 11. The gateway device 10 according to the present embodiment is provided with two in-vehicle communication units 13, and information received by one of the in-vehicle communication units 13 is transmitted from the other one of the in-vehicle communication units 13, so that transmission and reception of the information communicated between the communication wires are relayed.

The wireless communication unit 14 can use wireless communication such as, for example, a mobile telephone communication network or a wireless Local Area Network (LAN) to wirelessly communicate with a device provided outside the vehicle 1, and thus can communicate with the server device 3. When information to be transmitted to the server device 3 is given from the processing unit 11, the wireless communication unit 14 outputs, from an antenna, signals obtained by modulating this information to wirelessly transmit the information, and the wireless communication unit 14 receives information from the server device 3 by demodulating signals received at the antenna, and gives the received information to the processing unit 11. Note that the present embodiment has a configuration in which the gateway device 10 is provided with the wireless communication unit 14, but the present disclosure is not limited to this, and a configuration is also possible in which the gateway device 10 is not provided with the wireless communication unit 14 but communicates with the server device 3 via another wireless communication device installed in the vehicle 1.

Furthermore, the processing unit 11 of the gateway device 10 according to the present embodiment executes programs stored in the storage unit 12 to realize software functional blocks such as an information collecting unit 21, a vehicle information transmitting unit 22, a setting information receiving unit 23, and a setting updating unit 24. The information collecting unit 21 performs processing for collecting, from information received by the in-vehicle communication units 13, information to be transmitted to the server device 3, and storing the collected information in the storage unit 12. In the present embodiment, information to be transmitted to the server device 3 by the gateway device 10 refers to information required for determining the time to replace consumables of vehicle 1, namely, for example, information relating to the travel distance and travel time of the vehicle 1. In the transmission allowability table 12a of the storage unit 12, for example, a CAN ID assigned to information to be transmitted is stored in association with a setting as to whether or not it is allowed to be transmitted. Note that, in the transmission allowability table 12a, it is sufficient that a transmission allowability setting is registered for the ID assigned to at least one set of information that is used to determine the time to replace a consumable, but it is also possible that transmission allowability settings are registered for the IDs of all sets of information to be transmitted/received within the vehicle 1. Furthermore, the information collecting unit 21 may be configured to collect only information that is allowed to be transmitted based on the transmission allowability table 12a of the storage unit 12, but may also be configured to collect information that is not allowed to be transmitted. As a result of collecting information that is not allowed to be transmitted just in case, if this information is allowed to be transmitted, the gateway device 10 can also transmit the previous information.

The vehicle information transmitting unit 22 performs processing for reading information collected by the information collecting unit 21 and stored in the storage unit 12, and giving the read information to the wireless communication unit 14, so as to transmit this information to the server device 3. At this time, the vehicle information transmitting unit 22 references the transmission allowability table 12a of the storage unit 12, and transmits, to the server device 3, only the information allowed to be transmitted. Furthermore, the vehicle information transmitting unit 22 may also transmit information at a predetermined timing such as a timing at which, for example, the IG switch of the vehicle 1 is turned on/off, and may also transmit information at intervals of, for example, several minutes, several tens of minutes, several hours, or several days. Note however that, in the present embodiment, the vehicle information transmitting unit 22 is assumed to transmit information when the IG switch of the vehicle 1 is turned on. Furthermore, in the following, information that is transmitted from the gateway device 10 of the vehicle 1 to the server device 3 is referred to as “vehicle information”.

The setting information receiving unit 23 performs processing for receiving, using the wireless communication unit 14, setting information transmitted from the server device 3. The setting updating unit 24 performs processing for updating settings of the transmission allowability table 12a stored in the storage unit 12, based on the setting information received from the server device 3 by the setting information receiving unit 23. In the vehicle consumable management system 100 according to the present embodiment, a user can suitably select a consumable of the vehicle 1 to be subjected to replacement time determination, that is, a consumable set as a management target, and the user can operate the smartphone 5 to select a consumable set as a management target. When such a selection operation is made by the user, information to be transmitted from the vehicle 1 also changes, and thus the smartphone 5 notifies the server device 3 of information required for replacement time determination as setting information, and the server device 3 transmits the setting information to the gateway device 10 of the vehicle 1. As a result of the gateway device 10 that has received this setting information updating the transmission allowability table 12a of the storage unit 12, information suitable for the selection by the user is transmitted by the gateway device 10.

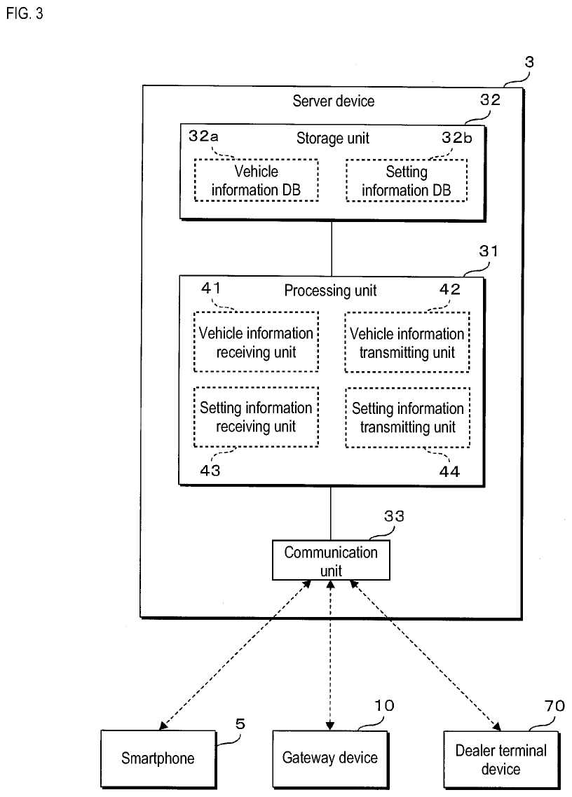

FIG. 3 is a block diagram showing a configuration of the server device 3. The server device 3 according to the present embodiment is provided with a processing unit (processor) 31, a storage unit (storage) 32, a communication unit 33, and the like. Note that, in the present embodiment, the server device 3 is constituted by a single device, but the present disclosure is not limited to this, and a plurality of devices may cooperate with each other to realize the server device 3. The processing unit 31 of the server device 3 is configured by an arithmetic processing unit such as a CPU or an MPU, and performs various types of processing such as calculation processing and control processing by reading and executing programs (illustration thereof is omitted) stored in the storage unit 32. For example, the processing unit 31 performs processing for receiving and storing vehicle information transmitted from the gateway device 10 of the vehicle 1, and transmitting the stored vehicle information to the smartphone 5, processing for receiving and storing setting information transmitted from the smartphone 5, and transmitting the stored setting information to the gateway device 10, and other processing.

The storage unit 32 is configured by, for example, a large capacity memory device such as a hard disk. The storage unit 32 stores programs that are executed by the processing unit 31, data required for the execution of the programs, and the like. Furthermore, the storage unit 32 of the server device 3 according to the present embodiment includes a vehicle information database (DB) 32a and a setting information DB 32b. The vehicle information DB 32a is a database in which vehicle information received from the gateway device 10 of the vehicle 1 is accumulated. The vehicle information DB 32a stores the vehicle information received from the gateway device 10 of the vehicle 1 in association with, for example, a vehicle ID, which is uniquely assigned to the vehicle 1. The setting information DB 32b is a database in which setting information received from the smartphone 5 used by the user is stored. The setting information DB 32b stores the setting information received from the smartphone 5 in association with, for example, a vehicle ID assigned to the corresponding vehicle 1. Note that the server device 3 stores information such as a device ID of the smartphone 5 or a user ID of the user of the smartphone 5 that corresponds to the vehicle ID of the vehicle 1, and can thus determine to which vehicle 1 setting information received from the smartphone 5 relates.

The communication unit 33 transmits and receives information to and from the smartphone 5, the gateway device 10, the dealer terminal device 70, and the like via a network such as, for example, the Internet or a mobile telephone communication network. The communication unit 33 transmits information given from the processing unit 31 to another device, and passes information received from another device to the processing unit 31.

Furthermore, the processing unit 31 of the server device 3 according to the present embodiment executes programs stored in the storage unit 32 to realize software functional blocks such as a vehicle information receiving unit 41, a vehicle information transmitting unit 42, a setting information receiving unit 43, and a setting information transmitting unit 44. The vehicle information receiving unit 41 performs processing for receiving, using the communication unit 33, vehicle information transmitted from the gateway device 10 of the vehicle 1, and storing the received vehicle information in the vehicle information DB 32a of the storage unit 32. The vehicle information transmitting unit 42 performs processing for transmitting, using the communication unit 33, the vehicle information stored in the vehicle information DB 32a to the smartphone 5 in accordance with a request from the smartphone 5.

The setting information receiving unit 43 performs processing for receiving, using the communication unit 33, setting information transmitted from the smartphone 5, and storing the received setting information in the setting information DB 32b of the storage unit 32. The setting information transmitting unit 44 performs processing for transmitting, using the communication unit 33, the setting information stored in the setting information DB 32b to the gateway device 10 in accordance with a request from the gateway device 10 of the vehicle 1.

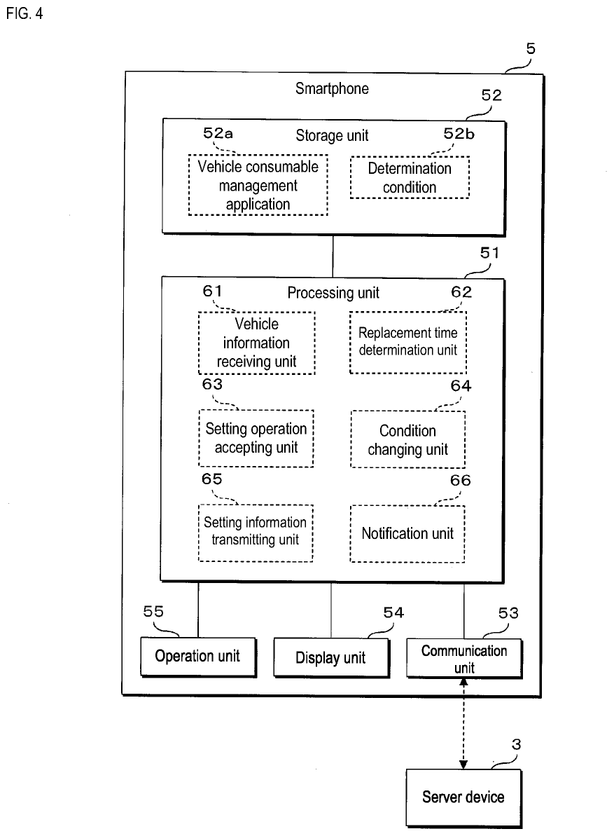

FIG. 4 is a block diagram showing a configuration of the smartphone 5. The smartphone 5 according to the present embodiment is provided with a processing unit (processor) 51, a storage unit (storage) 52, a communication unit 53, a display unit 54, an operation unit 55, and the like. The processing unit 51 is configured by an arithmetic processing unit such as a CPU or an MPU, and performs various types of processing such as calculation processing and control processing by reading and executing programs stored in the storage unit 52. In the present embodiment, by reading and executing a vehicle consumable management application 52a stored in the storage unit 52, the processing unit 51 performs processing such as processing for determining the time to replace consumables of vehicle 1 based on the vehicle information acquired from the server device 3, and processing for notifying the determined replacement time, and processing for accepting settings of determination conditions for use in replacement time determination.

The storage unit 52 is configured by a large capacity nonvolatile memory device such as, for example, a flash memory. The storage unit 52 stores programs that are executed by the processing unit 51, data required for the execution of the programs, and the like. Furthermore, in the storage unit 52 of the smartphone 5 according to the present embodiment, the vehicle consumable management application 52a that is executed by the processing unit 51, and a determination condition 52b for use in determining the time to replace consumables are stored. The vehicle consumable management application 52a is downloaded in advance from, for example, a server device that distributes applications for the smartphone, and is stored in the storage unit 52. Note however that a configuration is also possible in which the smartphone 5 reads a vehicle consumable management application 52a stored in a recording medium such as, for example, a memory card or an optical disk, and stores the read application in the storage unit 52. Alternatively, for example, a smartphone 5 with a vehicle consumable management application 52a preinstalled in a storage unit 52 may also be marketed. For the determination condition 52b of the storage unit 52, determination conditions for respective consumables of the vehicle 1 are stored.

The communication unit 53 can communicate with the server device 3 by performing wireless communication using, for example, a mobile telephone communication network, a wireless LAN, or the like. When information to be transmitted to the server device 3 is given from the processing unit 51, the communication unit 53 outputs, from the antenna, signals obtained by modulating this information to wirelessly transmit the information, and the communication unit 53 receives information from the server device 3 by demodulating signals received at the antenna, and gives the received information to the processing unit 51.

The display unit 54 is configured by, for example, a liquid crystal panel, and displays various images in accordance with a display command from the processing unit 51. The operation unit 55 detects a touch operation, a push operation, and the like of the user, using a touch panel provided on a display surface of the display unit 54, a push switch provided on the housing of the smartphone 5, and the like for example, and gives the detection result to the processing unit 51.

Furthermore, the processing unit 51 of the smartphone 5 according to the present embodiment executes the vehicle consumable management application 52a stored in the storage unit 52 to realize software functional blocks such as a vehicle information receiving unit 61, a replacement time determination unit 62, a setting operation accepting unit 63, a condition changing unit 64, a setting information transmitting unit 65, and a notification unit 66. The vehicle information receiving unit 61 performs processing for requesting, via communication using the communication unit 53, the server device 3 to transmit vehicle information, receiving the vehicle information that is transmitted in response to this request by the server device 3, and storing the received vehicle information in the storage unit 52.

The replacement time determination unit 62 performs processing for determining, based on the vehicle information received by the vehicle information receiving unit 61 and the determination condition 52b stored in the storage unit 52, the time to replace consumables of the vehicle 1. For example, if there is a consumable that is recommended to be replaced every ten thousand kilometers the vehicle 1 travels, the replacement time determination unit 62 determines, based on information relating to the last replacement date of this consumable and the current distance for which the vehicle 1 has traveled since the last replacement date, whether or not the travel distance after the replacement exceeds the determination condition of “ten thousand kilometers”. In the present embodiment, it is assumed that the smartphone 5 receives the replacement date of consumables and the travel distance of the vehicle 1 as vehicle information from the server device 3. Note however that a configuration is also possible in which the replacement date of consumables is, for example, stored and managed by the smartphone 5. Furthermore, in this case, for the determination condition 52b of the storage unit 52, a condition that the travel distance exceeds ten thousand kilometers is stored as a condition for determining a replacement time.

Furthermore, if the travel distance does not exceed ten thousand kilometers, the replacement time determination unit 62 calculates the remaining distance until the travel distance reaches ten thousand kilometers. Furthermore, the replacement time determination unit 62 performs processing for calculating, for example, an average travel distance of the vehicle 1 between the replacement time and the current time, a recent average travel distance, or the like, and determining an expected point in time at which a consumable needs to be replaced, the remaining time period, or the like.

The setting operation accepting unit 63 performs processing for accepting, using the operation unit 55, a user operation for changing a determination condition for use in determination performed by the replacement time determination unit 62. In the case of the above example, the condition that the travel distance exceeds ten thousand kilometers is set as the determination condition for consumables, but the user can increase or decrease this threshold to, for example, a value such as eight thousand kilometers or twelve thousand kilometers. The setting operation accepting unit 63 accepts a setting operation by a user and gives setting content that corresponds to the accepted operation to the condition changing unit 64. The condition changing unit 64 performs processing for changing the determination condition 52b of the storage unit 52 based on the given setting content.

Furthermore, the setting operation accepting unit 63 performs processing for accepting, using the operation unit 55, a user operation for selecting a consumable of the vehicle 1 to be subjected to management of this system. The vehicle 1 is equipped with a large number of consumables, and the user does not necessarily desire to be notified of the replacement time for all of the consumables. In the vehicle consumable management system 100 according to the present embodiment, the user can set, for the individual consumables, whether or not notification is to be performed. Upon accepting a setting operation for setting a consumable serving as a management target, the setting operation accepting unit 63 gives setting content that corresponds to the accepted operation to the setting information transmitting unit 65.

When a user operation for setting a consumable serving as a management target is accepted by the setting operation accepting unit 63, the setting information transmitting unit 65 performs processing for transmitting, using the communication unit 53, setting information that corresponds to the setting operation to the server device 3. For example, if the vehicle 1 is equipped with a sensor for detecting a residual amount of windshield washer fluid, and is configured to be able to transmit a detection result of this sensor as vehicle information to the server device 3, the setting information transmitting unit 65 transmits, in response to a setting operation that is made through the smartphone 5 to set the windshield washer fluid as a management target/non-management target, the fact that the detection result of the residual amount of the windshield washer fluid is to be/not to be transmitted, serving as setting information, to the server device 3. Note however that, in a case where, for example, both time to replace the engine oil and time to replace the windshield wiper blade rubber are determined based on the travel distance of the vehicle 1, even if a setting operation is made to set only one of them as a non-management target, the setting information transmitting unit 65 does not transmit setting information indicating that the travel distance does not need to be transmitted. If a setting operation is made to set all of consumables whose replacement time is determined based on the travel distance as non-management targets, the setting information transmitting unit 65 transmits setting information indicating that the travel distance does not need to be transmitted. Information correlating a consumable of the vehicle 1 and vehicle information for use in determination is stored in advance in the storage unit 52 for example, and the setting information transmitting unit 65 generates and transmits setting information in reference to the stored correspondence information.

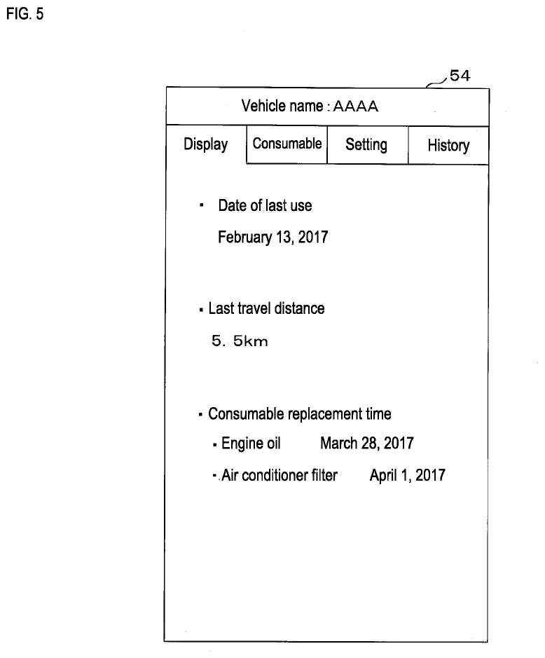

The notification unit 66 performs processing for notifying a user of the time to replace consumables that was determined by the replacement time determination unit 62. In the present embodiment, the notification unit 66 performs the notification processing by displaying, on the display unit 54 of the smartphone 5, a notification screen for notifying the user of information relating to consumables. FIGS. 5 to 7 are diagrams schematically illustrating examples of the notification screens displayed on the smartphone 5. FIG. 5 shows a notification screen that is first displayed after the vehicle consumable management application 52a is booted on the smartphone 5. In the present example, at the uppermost position of the notification screen displayed on the display unit 54 of the smartphone 5, a registered vehicle name of the vehicle 1 is displayed, and four tabs are provided below the registered vehicle name. The four tabs of the present example include “Display”, “Consumable”, Setting”, and “History”, and FIG. 5 shows a state in which the “Display” tab is selected. Immediately after booting up the vehicle consumable management application 52a, the “Display” tab is selected.

The notification screen (see FIG. 5) in the state in which the “Display” tab is selected displays, for example, “Date of last use: Feb. 13, 2017”, serving as information relating to the date when the vehicle 1 was last used, and “Last travel distance: 5.5 km”, serving as information relating to the distance for which the vehicle 1 traveled during the last use. The information on the date and the distance is information contained in the vehicle information received from the server device 3. Furthermore, in the lower portion of the notification screen of the present example, the item “Consumable replacement time” is provided as information relating to the time to replace consumables equipped in the vehicle 1, and information “Engine oil: Mar. 28, 2017” and “Air conditioner filter: Apr. 1, 2017” is displayed as specific replacement time of the consumables. Note that information on consumables displayed in the lower portion of the notification screen of the “Display” tab relates to a consumable whose replacement time is determined to have elapsed by the replacement time determination unit 62, and a consumable whose replacement time is approaching, and no information is displayed that relates to a consumable that has sufficient time remaining until its replacement time. “Consumable whose replacement time is approaching” may refer to, for example, a consumable that has a shorter time remaining until the replacement time determined by the replacement time determination unit 62 than a predetermined time period such as one month, or a consumable for which the residual travel distance is smaller than a predetermined distance such as 100 km, or the like. In the shown example, notification is performed that the replacement time for the engine oil and the replacement time for the air conditioner filters of the vehicle 1 are approaching.

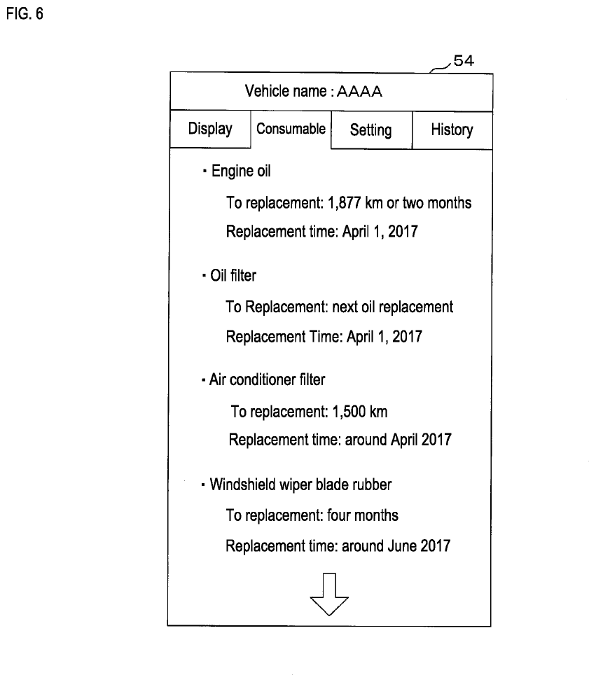

The notification screen (see FIG. 6) in the state in which the “Consumable” tab is selected displays a list of consumables equipped in the vehicle 1. In the shown example, information on four types of consumables, namely, engine oil, oil filters, air conditioner filters, and windshield wiper blade rubber is displayed in the list. Furthermore, in the shown example, as information relating to the engine oil, information “To replacement: 1,877 km or two months” and “Replacement time: Apr. 1, 2017” is displayed, and as information relating to the oil filters, information “To replacement: next oil replacement” and “Replacement time: Apr. 1, 2017” is displayed, and as information relating to the air conditioner filters, information “To replacement: 1,500 km” and “Replacement time: around April 2017” is displayed, and as information relating to the windshield wiper blade rubber, information “To replacement: four months” and “Replacement time: around June 2017” is displayed. These types of display indicate some of the large number of consumables equipped in the vehicle 1, and the user can perform a scrolling operation in the vertical direction on the notification screen so that information relating to other consumables can be displayed. Furthermore, to each consumable, information is added that relates to replacement time, and to the travel distance or the time period until the replacement, and this information is based on results of determination of the replacement time determination unit 62. Note that, in the present embodiment, a user can select consumables to be set as management targets by the vehicle consumable management system 100, and the notification screen of the “Consumable” tab displays a list of the consumables selected as management targets without consumables that are not selected as management targets.

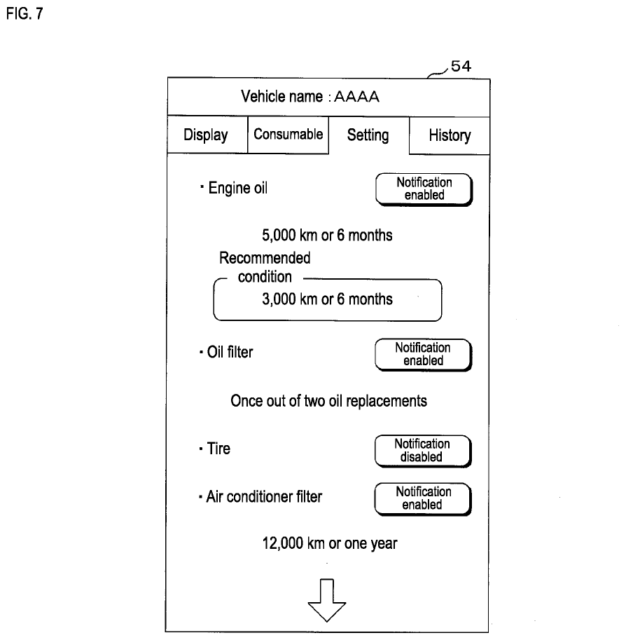

The notification screen (see FIG. 7) in the state in which the “Setting” tab is selected displays a list of conditions for determining the time to replace consumables equipped in the vehicle 1, and a user can perform an operation for changing settings on this notification screen. In the shown example, information on four types of consumables, namely, engine oil, oil filters, tires, and air conditioner filters is displayed in the list. On the notification screen of the “Setting” tab, to each of the consumables, an indication “Notification enabled” or “Notification disabled” is added as a setting as to whether or not replacement time is to be notified. The user can perform a touch operation on the indication “notification enabled” or “notification disabled” to alternately switch the setting between the two states “notification enabled” and “notification enabled”. An acceptance of this switching operation corresponds to an acceptance of an operation for selecting a consumable set as a management target by the setting operation accepting unit 63.

Furthermore, on the notification screen of the “Setting” tab, determination conditions for replacement time are displayed for the consumables for which “notification enabled” is set. In the shown example, “5,000 km or 6 months” is set as a determination condition for the engine oil, “Once out of two oil replacements” is set as a determination condition for the oil filters, and “12,000 km or one year” is set as a determination condition for the air conditioner filters. With respect to the tires for which “notification disabled” is set, no determination condition is displayed. When the user performs a touch operation on a determination condition for a consumable, an input screen (illustration thereof is omitted) for the determination condition is further displayed, and the user can, for example, increase/decrease or directly input a condition value. An acceptance of this setting operation for a determination condition corresponds to an acceptance of a setting operation by the setting operation accepting unit 63.

Furthermore, on the notification screen of the “Setting” tab, for a consumable whose determination condition was changed by the user, a “Recommended condition” is displayed that is recommended as a determination condition for replacement time of this consumable. In the shown example, the determination condition for the engine oil was changed by the user, and “3,000 km or 6 Months” is displayed as a recommended condition for the engine oil. By displaying such a recommended condition, it is possible for a user to recognize the fact that the determination condition was changed, what is the difference between the changed determination condition and the recommended condition, and the like.

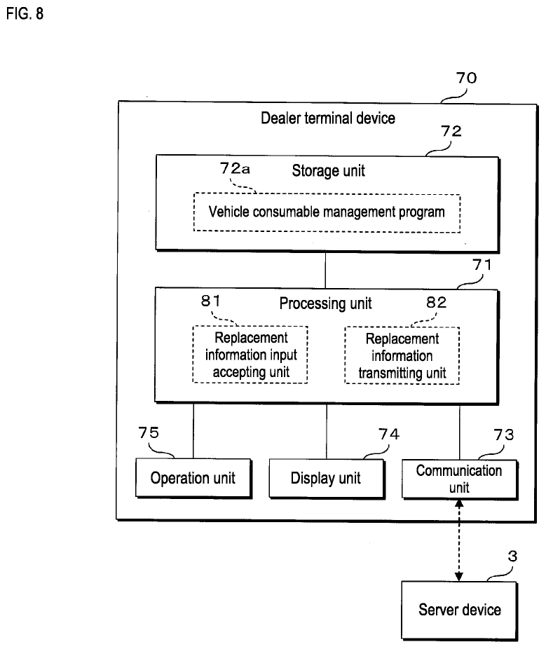

FIG. 8 is a block diagram showing a configuration of the dealer terminal device 70. The dealer terminal device 70 according to the present embodiment is a device for the vehicle consumable management system 100 according to the present embodiment, the device being obtained by installing a vehicle consumable management program 72a in a general-purpose computer such as a personal computer (PC) or a tablet terminal device provided at the dealer 7 of the vehicle 1. The dealer terminal device 70 is a device for managing, for example, information on the vehicle 1, information on the user of the vehicle 1, and the like, and in the present embodiment, the dealer terminal device 70 is used as a device that notifies, when a consumable of the vehicle 1 is, for example, replaced or refilled by the dealer 7, the server device 3 of information relating to the replacement date.

The dealer terminal device 70 according to the present embodiment is provided with a processing unit (processor) 71, a storage unit (storage) 72, a communication unit 73, a display unit 74, an operation unit 75, and the like. The processing unit 71 is configured by an arithmetic processing unit such as a CPU or an MPU, and performs various types of processing such as calculation processing and control processing by reading and executing programs stored in the storage unit 72. In the present embodiment, by reading and executing the vehicle consumable management program 72a stored in the storage unit 72, the processing unit 71 performs processing such as processing for accepting an input of information relating to replacement of a consumable of the vehicle 1, and processing for transmitting the accepted replacement information to the server device 3.

The storage unit 72 is configured by a large capacity memory device such as, for example, a hard disk device or a flash memory. The storage unit 72 stores programs that are executed by the processing unit 71, data required for the execution of the programs, and the like. Furthermore, the storage unit 72 of the dealer terminal device 70 according to the present embodiment stores the vehicle consumable management program 72a that is executed by the processing unit 71. The vehicle consumable management program 72a that is recorded in, for example, a recording medium such as an optical disk or a memory card, or that is downloaded from a server device that distributes the program via a network is installed in advance in the storage unit 72.

The communication unit 73 can communicate with the server device 3 by performing communication via the Internet, for example. The communication unit 73 transmits information given from the processing unit 71 to the server device 3, and passes information received from the server device 3 to the processing unit 71. The display unit 74 is configured by, for example, a liquid crystal display, and may also be integrated with or separated from the dealer terminal device 70. The display unit 74 displays various images in accordance with a display command given from the processing unit 71. The operation unit 75 detects a user operation using, for example, a mouse, a keyboard, a touch panel provided on the display screen of the display unit 74, or the like, and gives the detection result to the processing unit 71.

Furthermore, the processing unit 71 of the dealer terminal device 70 according to the present embodiment executes the vehicle consumable management program 72a stored in the storage unit 72 to realize software functional blocks such as a replacement information input accepting unit 81 and a replacement information transmitting unit 82. When the vehicle 1 is subjected to inspection, repair, or the like at the dealer 7, the replacement information input accepting unit 81 performs processing for accepting an input of information relating to a consumable that was, for example, replaced or refilled. The replacement information transmitting unit 82 performs processing for transmitting the replacement information accepted by the replacement information input accepting unit 81 to the server device 3 using the communication unit 73. The replacement information transmitted to the server device 3 by the replacement information transmitting unit 82 contains, for example, information for identifying the replaced consumable of the vehicle 1, information relating to the date when this consumable was replaced, and the like.

The server device 3 that has received the replacement information from the dealer terminal device 70 registers this replacement information in the vehicle information DB 32a of the storage unit 32. Then, upon a request to acquire vehicle information from the smartphone 5, the vehicle information transmitting unit 42 of the server device 3 adds the replacement information registered in the vehicle information DB 32a to the vehicle information, and transmits the resulting information to the smartphone 5. The smartphone 5 that has received the replacement information contained in the vehicle information from the server device 3 calculates the travel distance, elapsed time, or the like with respect to the replacement date of the consumable of the vehicle 1 serving as a reference, so as to determine a replacement time.

Note that the present embodiment employs a configuration in which, when a consumable of the vehicle 1 is, for example, replaced or refilled, replacement information is input by the dealer terminal device 70, but the present disclosure is not limited to this. For example, a configuration may also be employed in which the replacement information is input by the smartphone 5 of the user. In this configuration, the smartphone 5 that has accepted an input of replacement information may transmit or not transmit the replacement information to the server device 3. Note however that, with the configuration in which the smartphone 5 transmits replacement information to the server device 3, the user can, for example, share information relating to consumables of the vehicle 1 with another terminal device such as a PC, a tablet terminal device, or another smartphone 5.

The following will describe pieces of processing that are executed by the constituent components of the vehicle consumable management system 100 according to the present embodiment with reference to flowcharts. Note that, in order to use the vehicle consumable management system 100, a user needs to install the vehicle consumable management application 52a to the smartphone 5, boot the installed vehicle consumable management application 52a to communicate with the server device 3, and register in advance information such as, for example, a user ID, a vehicle ID, and a password in the server device 3. Furthermore, the user also needs to register in advance information relating to the gateway device 10 of the vehicle 1 in the server device 3, so as to be able to exchange information with the server device 3 (note however that the registration of information may also be performed by the dealer 7 of the vehicle 1, or the like, instead of the user). After successful completion of the registration of information, the user can use the vehicle consumable management system 100, and can transmit vehicle information from the gateway device 10 of the vehicle 1 to the server device 3. Thereafter, the user can execute the vehicle consumable management application 52a on the smartphone 5 to check information relating to consumables of the vehicle 1. In the following, description of the initial registration procedure above is omitted, and the procedure that is executed after completion of the initial registration will be described.

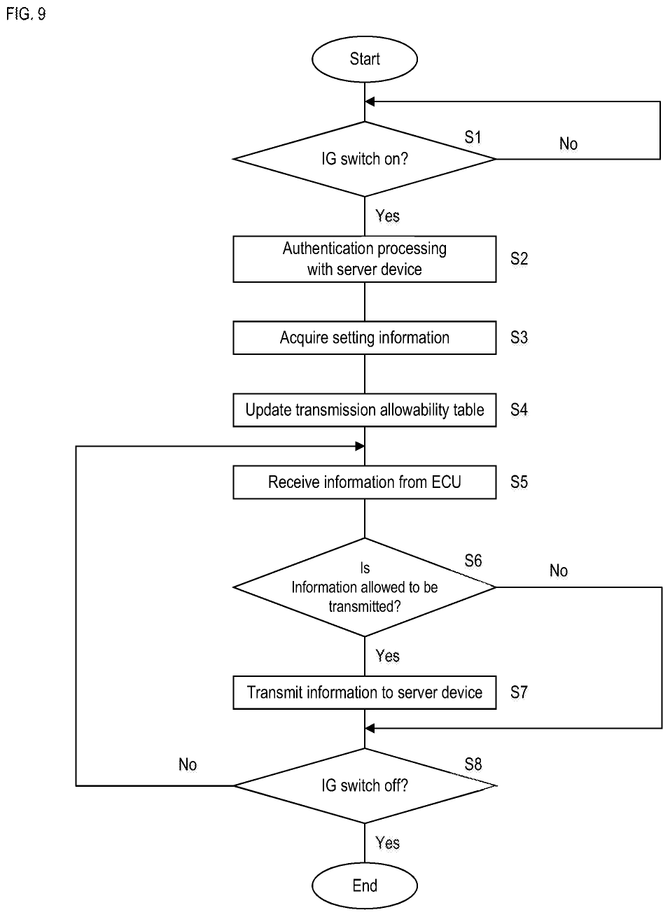

FIG. 9 is a flowchart showing the procedure of processing that is executed by the gateway device 10 of the vehicle 1. The processing unit 11 of the gateway device 10 according to the present embodiment determines whether or not the IG switch of the vehicle 1 has been switched on from off (step S1). If the IG switch has not been switched on (NO in step S1), the processing unit 11 stands by until the IG switch is switched on. If the IG switch has been switched on (YES in step S1), the processing unit 11 communicates with the server device 3 using the wireless communication unit 14 to transmit information such as a vehicle ID and a password to the server device 3, and performs authentication processing with the server device 3 (step S2). Note that, in this flowchart, illustration of processing that is executed when the authentication processing between the gateway device 10 and the server device 3 has failed is omitted.

The setting information receiving unit 23 of the processing unit 11 that has successfully completed the authentication processing with the server device 3 requests the server device 3 to transmit setting information, and receives setting information transmitted from the server device 3 as a response to this request, thereby acquiring the setting information from the server device 3 (step S3). The setting updating unit 24 of the processing unit 11 updates the transmission allowability table 12a stored in the storage unit 12 based on the received setting information (step S4).

Then, the information collecting unit 21 of the processing unit 11 receives, using an in-vehicle communication unit 13, information from an ECU 2 of the vehicle 1 (step S5), and stores the received information in the storage unit 12. The vehicle information transmitting unit 22 of the processing unit 11 references the transmission allowability table 12a stored in the storage unit 12, and determines whether or not the information received from the ECU 2 is allowed to be transmitted (step S6). If the information is allowed to be transmitted (YES in step S6), the vehicle information transmitting unit 22 transmits the information received from the ECU 2 to the server device using the wireless communication unit 14 (step S7), and the procedure moves to step S8. If the information is not allowed to be transmitted (NO in step S6), the vehicle information transmitting unit 22 does not transmit the information received from the ECU 2 to the server device 3 and the procedure moves to step S8.

Then, the processing unit 11 determines whether or not the IG switch of the vehicle 1 has been switched off from on (step S8). If the IG switch has not been switched off (NO in step S8), the processing unit 11 returns to step S5 to transmit again vehicle information. If the IG switch has been switched off (YES in step S8), the processing unit 11 ends the processing for transmitting the vehicle information.

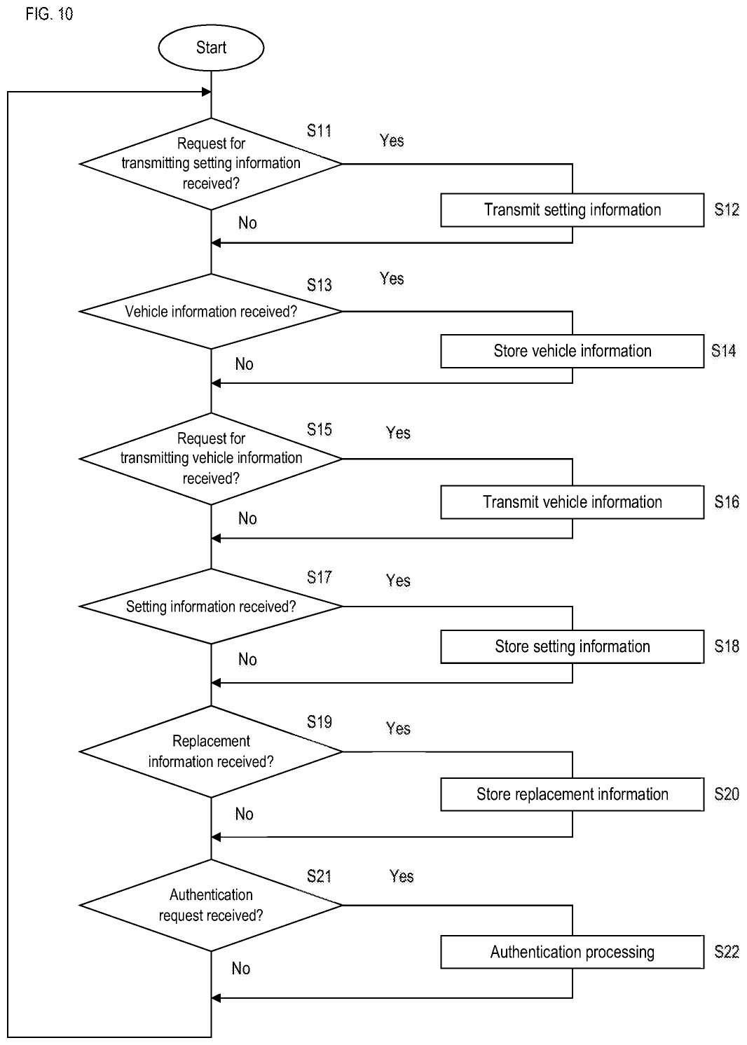

FIG. 10 is a flowchart showing the procedure of processing that is executed by the server device 3. The setting information transmitting unit 44 of the processing unit 31 of the server device 3 according to the present embodiment determines whether or not a request for transmitting setting information has been received from the gateway device 10 by the communication unit 33 (step S11). If a request for transmitting setting information has been received (YES in step S11), the setting information transmitting unit 44 reads setting information stored in the setting information DB 32b of the storage unit 32 and transmits the read setting information to the gateway device 10 that has transmitted this request (step S12), and the procedure moves to step S13. If a request for transmitting setting information has not been received (NO in step S11), the setting information transmitting unit 44 does not transmit the setting information, and the procedure moves to step S13.

The vehicle information receiving unit 41 of the processing unit 31 determines whether or not vehicle information has been received from the gateway device 10 by the communication unit 33 (step S13). If the vehicle information has been received (YES in step S13), the vehicle information receiving unit 41 stores the received vehicle information in the vehicle information DB 32a of the storage unit 32 (step S14), and the procedure moves to step S15. If no vehicle information has been received (NO in step S13), the vehicle information receiving unit 41 moves to processing in step S15.

The vehicle information transmitting unit 42 of the processing unit 31 determines whether or not a request for transmitting vehicle information from the smartphone 5 has been received by the communication unit 33 (step S15). If the request for transmitting vehicle information has been received (YES in step S15), the vehicle information transmitting unit 42 reads vehicle information stored in the vehicle information DB 32a of the storage unit 32 and transmits the read vehicle information to the smartphone 5 that has transmitted this request (step S16), and the procedure moves to step S17. If no request for transmitting vehicle information has been received (NO in step S15), the vehicle information transmitting unit 42 does not transmit the vehicle information, and the procedure moves to step S17.

The setting information receiving unit 43 of the processing unit 31 determines whether or not setting information has been received from the smartphone 5 by the communication unit 33 (step S17). If setting information has been received (YES in step S17), the setting information receiving unit 43 stores the received setting information in the setting information DB 32b of the storage unit 32 (step S18), and the procedure moves to step S19. If no setting information has been received (NO in step S17), the setting information receiving unit 43 moves to processing in step S19.

The processing unit 31 determines whether or not replacement information has been received from the dealer terminal device 70 by the communication unit 33 (step S19). If replacement information has been received (YES in step S19), the processing unit 31 stores the received replacement information in the vehicle information DB 32a of the storage unit 32 (step S20), and the procedure moves to step S21. If no replacement information has been received (NO in step S19), the processing unit 31 moves to processing in step S21.

The processing unit 31 determines whether or not an authentication request has been received, using the communication unit 33, from the gateway device 10, the smartphone 5, or the dealer terminal device 70 (step S21). If an authentication request has been received (YES in step S21), the processing unit 31 transmits/receives information such as an ID and a password to/from the device that has transmitted the authentication request, and performs authentication processing (step S22), and the procedure returns to step S11. If no authentication request has been received (NO in step S21), the processing unit 31 does not perform authentication processing, and the procedure returns to step S11.

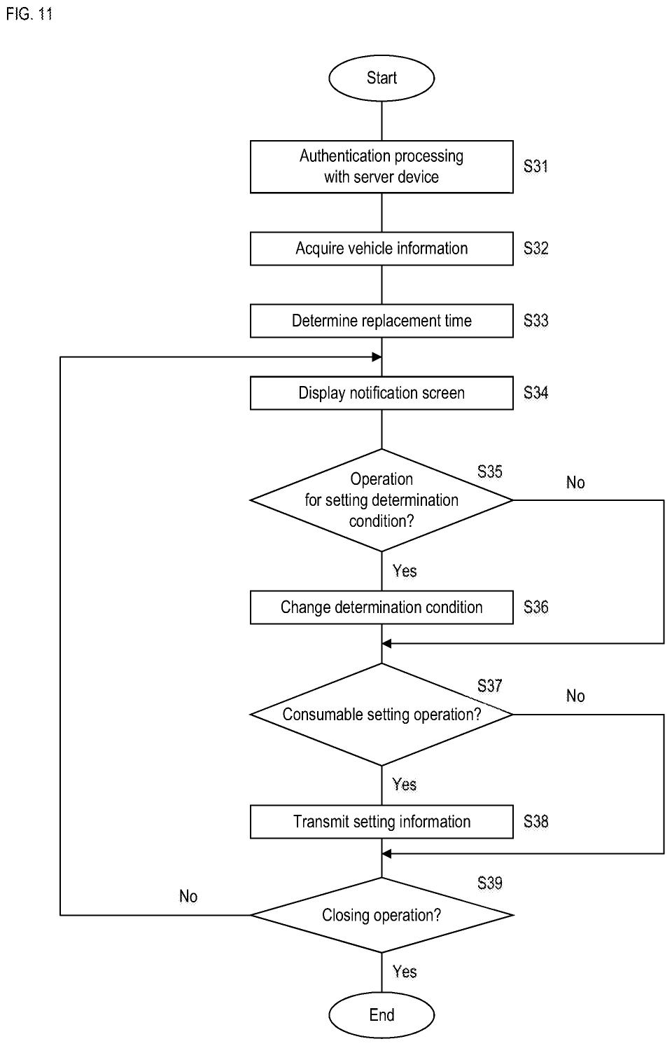

FIG. 11 is a flowchart showing the procedure of processing that is executed by the smartphone 5. The processing unit 51 of the smartphone 5 according to the present embodiment executes the vehicle consumable management application 52a stored in the storage unit 52 to start processing relating to management of consumables of the vehicle 1. The processing unit 51 communicates with the server device 3 using the communication unit 53 to transmit information such as a user ID and a password to the server device 3, and performs authentication processing with the server device 3 (step S31). Note that, in this flowchart, illustration of processing that is executed when the authentication processing between the smartphone 5 and the server device 3 has failed is omitted.

The vehicle information receiving unit 61 of the processing unit 51 that has successfully completed the authentication processing with the server device 3 requests the server device 3 to transmit vehicle information, and receives vehicle information transmitted from the server device 3 as a response to this request, thereby acquiring the vehicle information from the server device 3 (step S32). The replacement time determination unit 62 of the processing unit 51 performs processing for determining the time to replace consumables of vehicle 1, based on the received vehicle information and the determination condition 52b stored in the storage unit 52 (step S33).

Then, the notification unit 66 of the processing unit 51 displays, on the display unit 54, a notification screen for performing notification of the time to replace consumables of the vehicle 1 based on a result of the replacement time determination executed in step S33 (step S34). After the display of the notification screen, the setting operation accepting unit 63 of the processing unit 51 determines whether or not an operation for setting a determination condition for determining the time to replace a consumable has been accepted by the operation unit 55 (step S35). If an operation for setting a determination condition has been accepted (YES in step S35), the condition changing unit 64 of the processing unit 51 changes the determination condition 52b stored in the storage unit 52 based on the accepted setting operation (step S36), and the procedure moves to step S37. If no operation for setting a determination condition has been accepted (NO in step S35), the processing unit 51 moves to processing in step S37.

The setting operation accepting unit 63 of the processing unit 51 determines whether or not a user's setting operation for selecting a consumable of the vehicle 1 that is to be set as a management target of the present system has been accepted by the operation unit 55 (step S37). If a setting operation for selecting a consumable has been accepted (YES in step S37), the setting information transmitting unit 65 of the processing unit 51 generates setting information that corresponds to the accepted setting operation, and transmits the generated setting information to the server device 3 using the communication unit 53 (step S38), and the procedure moves to step S39. If no setting operation for selecting a consumable has been accepted (NO in step S37), the processing unit 51 moves to processing in step S39.

The processing unit 51 determines whether or not an operation for closing the vehicle consumable management application 52a has been accepted by the operation unit 55 (step S39). If no closing operation has been accepted (NO in step S39), the processing unit 51 returns to the processing in step S34, and performs again processing for displaying the notification screen and accepting a setting operation, for example. If a closing operation has been accepted (YES in step S39), the processing unit 51 ends the processing of the vehicle consumable management application 52a.

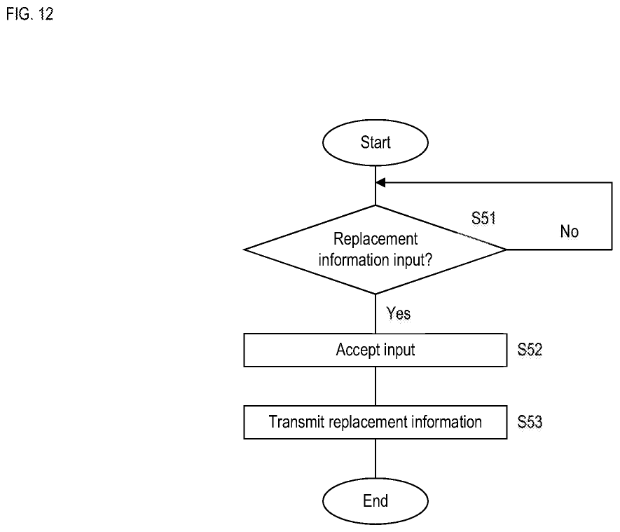

FIG. 12 is a flowchart showing the procedure of processing that is executed by the dealer terminal device 70. The replacement information input accepting unit 81 of the processing unit 71 of the dealer terminal device 70 according to the present embodiment determines whether or not information relating to replacement of a consumable of the vehicle 1 has been input by the operation unit 75 (step S51). If replacement information has not been input (NO in step S51), the replacement information input accepting unit 81 stands by until replacement information is input. If replacement information has been input (YES in step S51), the replacement information input accepting unit 81 accepts the input of the replacement information (step S52). Then, the replacement information transmitting unit 82 of the processing unit 71 transmits the input replacement information to the server device 3 using the communication unit 73 (step S53), and ends the procedure.

In the vehicle consumable management system 100 with the above-described configurations according to the present embodiment, the gateway device 10 installed in the vehicle 1 collects information relating to consumables of the vehicle 1, and transmits the collected information to the server device 3, and the server device 3 stores the received vehicle information in the vehicle information DB 32a of the storage unit 32. The smartphone 5 that is used by a user receives the vehicle information from the server device 3, determines, based on the received vehicle information and the determination condition 52b stored in the storage unit 52, a time to, for example, replace or refill the consumables of the vehicle 1, displays, on the display unit 54, results of the determination as a notification screen, and notifies the user of the results of the determination. Furthermore, the smartphone 5 accepts, by the operation unit 55, an operation for setting a determination condition for determining the replacement time, and changes the determination condition 52b stored in the storage unit 52. Accordingly, a user's intention can be reflected in the determination condition for determining the time to, for example, replace or refill consumables of the vehicle 1. Moreover, as a result of the smartphone 5 accepting an operation for setting a determination condition, convenience when the user performs setting operation can be improved.

Furthermore, the gateway device 10 stores, for each type of information (ID of information), settings as to whether or not it is allowed to be transmitted to the outside of the vehicle in the transmission allowability table 12a of the storage unit 12, and the gateway device 10 transmits, to the server device 3, information that is allowed to be transmitted based on the transmission allowability table 12a, and does not transmit information that is not allowed to be transmitted. Accordingly, it is possible to suppress transmission of unnecessary information from the gateway device 10 to the server device 3, making it possible to reduce communication loads. Furthermore, the smartphone 5 accepts, by the operation unit 55, a user's setting operation for selecting a consumable of the vehicle 1 that is to be subjected to management by the present system, that is, an operation based on the setting of the transmission allowability table 12a of the gateway device 10, and transmits setting information that corresponds to the accepted operation to the server device 3. The server device 3 that has received the setting information from the smartphone 5 stores the received setting information in the setting information DB 32b of the storage unit 32 and transmits the setting information to the gateway device 10. The gateway device 10 updates the transmission allowability table 12a stored in the storage unit 12 based on the setting information received from the server device 3. Accordingly, it is possible to reflect a user's intention, and restrict information transmission by the gateway device 10.

Furthermore, the smartphone 5 displays, on the display unit 54, a first notification screen (see FIG. 5) that contains information relating to a consumable whose replacement time has come, or a consumable whose replacement time is within a predetermined time period. Accordingly, the user can view the first notification screen displayed on the smartphone 5 to easily determine whether or not a consumable of the vehicle 1 needs to be replaced.

Furthermore, the smartphone 5 displays, on the display unit 54, a second notification screen (see FIG. 6) that indicates a list of consumables of the vehicle 1, each consumable being associated with a replacement time. Accordingly, the user can view the second notification screen displayed on the smartphone 5 to easily recognize what kinds of consumables the vehicle 1 is equipped with, how close replacement time of the consumables is approaching, and the like.

Furthermore, the smartphone 5 displays, on the display unit 54, a determination condition notification screen (see FIG. 7) that indicates a list of consumables of the vehicle 1, each consumable being associated with a determination condition for use in replacement time determination, and accepts, on this determination condition notification screen, an operation for setting a determination condition. Accordingly, the user can easily recognize in what condition each consumable needs to be replaced, and can easily change the determination condition based on the user's own judgment. Furthermore, the smartphone 5 may also display a determination condition set for each consumable, as well as a recommended determination condition for this consumable. Accordingly, the user can easily determine whether or not the determination condition has been changed, and can easily recognize a difference between the determination condition set by himself or herself, and the recommended determination condition.

Note that the present embodiment has employ a configuration in which determination of the replacement time is performed by the smartphone 5, but the present disclosure is not limited to this. For example, determination of the replacement time is performed by the server device 3. In this configuration, a determination condition for use in replacement time determination processing is stored in the server device 3, and if an operation for setting a determination condition is accepted by the smartphone 5, the smartphone 5 transmits the accepted determination condition to the server device 3. Upon a request for transmitting vehicle information from the smartphone 5, the server device 3 determines the replacement time of a consumable, and transmits, to the smartphone 5, a result of the determination of the replacement time together with the vehicle information. The smartphone 5 displays the notification screen based on the vehicle information and the result of the determination of the replacement time received from the server device 3. Furthermore, a configuration is also possible in which the server device 3 generates a notification screen and transmits the generated notification screen to the smartphone 5, and the smartphone 5 that has received this displays the notification screen.

1. A vehicle consumable management system comprising:
an on-board communication device that is installed in a vehicle, and includes an information collecting unit configured to collect information relating to consumables of the vehicle, and a vehicle information transmitting unit configured to transmit the information collected by the information collecting unit to a device outside the vehicle;
a vehicle-external device that includes a vehicle information receiving unit configured to receive the information transmitted by the on-board communication device, a vehicle information storage unit configured to store the information received by the vehicle information receiving unit, and a vehicle information transmitting unit configured to transmit the information stored in the vehicle information storage unit to a terminal device; and
a terminal device that includes a vehicle information receiving unit configured to receive the information transmitted by the vehicle-external device, a replacement time determination unit configured to determine, based on the information received by the vehicle information receiving unit and a predetermined determination condition, a time to replace a consumable of the vehicle, an accepting unit configured to accept a setting operation for setting the determination condition, a condition changing unit configured to change the determination condition based on the setting operation accepted by the accepting unit, and a notification unit configured to perform notification of the time to replace the consumable of the vehicle based on a result of the determination performed by the replacement time determination unit.

2. The vehicle consumable management system according to claim 1,
wherein the on-board communication device includes a transmission allowability table in which, for each type of information, a setting as to whether or not the information is allowed to be transmitted to the outside of the vehicle is stored, and
the vehicle information transmitting unit of the on-board communication device transmits information that is allowed to be transmitted based on the transmission allowability table.

3. The vehicle consumable management system according to claim 2,
wherein the terminal device includes an accepting unit configured to accept an operation for setting the transmission allowability table, and a setting information transmitting unit configured to transmit, to the vehicle-external device, setting information that corresponds to the setting operation accepted by the accepting unit,
the vehicle-external device includes a setting information receiving unit configured to receive the setting information transmitted by the terminal device, and a setting information storage unit configured to store the setting information received by the setting information receiving unit, and a setting information transmitting unit configured to transmit the information stored in the setting information storage unit to the on-board communication device, and
the on-board communication device includes a setting information receiving unit configured to receive the setting information transmitted by the vehicle-external device, and a setting updating unit configured to update settings of the transmission allowability table based on the setting information received by the setting information receiving unit.

4. The vehicle consumable management system according to claim 1, wherein the notification unit of the terminal device performs processing for displaying, on a display unit, a first notification screen that contains information relating to a consumable whose replacement time determined by the replacement time determination unit has come, or a consumable whose replacement time is within a predetermined time period.

5. The vehicle consumable management system according to claim 4, wherein the notification unit of the terminal device performs processing for displaying, on the display unit, a second notification screen that indicates a list of consumables of the vehicle, each consumable being associated with a replacement time determined by the replacement time determination unit.

6. The vehicle consumable management system according to claim 4, wherein the notification unit of the terminal device performs processing for displaying, on the display unit, a determination condition notification screen that indicates a list of consumables of the vehicle, each consumable being associated with a determination condition for use in determination performed by the replacement time determination unit, and
the accepting unit of the terminal device accepts an operation for setting the determination condition on the determination condition notification screen displayed on the display unit.

7. The vehicle consumable management system according to claim 6, wherein the determination condition notification screen displays a determination condition set for each consumable, as well as information regarding a recommended determination condition.

8. A terminal device comprising:
a vehicle information receiving unit configured to receive information relating to consumables of a vehicle that is transmitted from a vehicle-external device;
a replacement time determination unit configured to determine, based on the information received by the vehicle information receiving unit and a predetermined determination condition, a time to replace a consumable of the vehicle;
an accepting unit configured to accept a setting operation for setting the determination condition;
a condition changing unit configured to change the determination condition based on the setting operation accepted by the accepting unit; and
a notification unit configured to perform notification of the time to replace the consumable of the vehicle based on a result of the determination performed by the replacement time determination unit.

9. A computer program for causing a computer to function as:
a vehicle information receiving unit configured to receive information relating to consumables of a vehicle that is transmitted from a vehicle-external device;
a replacement time determination unit configured to determine, based on the information received by the vehicle information receiving unit and a predetermined determination condition, a time to replace a consumable of the vehicle;
an accepting unit configured to accept a setting operation for setting the determination condition;
a condition changing unit configured to change the determination condition based on the setting operation accepted by the accepting unit; and
a notification unit configured to perform notification of the time to replace the consumable of the vehicle based on a result of the determination performed by the replacement time determination unit.

10. A vehicle consumable management method comprising the steps of:
collecting, by a vehicle, information relating to consumables and transmitting the collected information to the outside of the vehicle;
determining, based on the information transmitted by the vehicle and a predetermined determination condition, a time to replace a consumable of the vehicle;
accepting a setting operation for setting the determination condition;
changing the determination condition based on the accepted setting operation; and
performing notification of the time to replace the consumable of the vehicle based on a result of the determination.

11. The vehicle consumable management system according to claim 2, wherein the notification unit of the terminal device performs processing for displaying, on a display unit, a first notification screen that contains information relating to a consumable whose replacement time determined by the replacement time determination unit has come, or a consumable whose replacement time is within a predetermined time period.

12. The vehicle consumable management system according to claim 3, wherein the notification unit of the terminal device performs processing for displaying, on a display unit, a first notification screen that contains information relating to a consumable whose replacement time determined by the replacement time determination unit has come, or a consumable whose replacement time is within a predetermined time period.

13. The vehicle consumable management system according to claim 5, wherein the notification unit of the terminal device performs processing for displaying, on the display unit, a determination condition notification screen that indicates a list of consumables of the vehicle, each consumable being associated with a determination condition for use in determination performed by the replacement time determination unit, and
the accepting unit of the terminal device accepts an operation for setting the determination condition on the determination condition notification screen displayed on the display unit.
